(19) United States
(12) Patent Application Publication
(10) Pub. No.: US 2013/0058526 A1
(43) Pub. Date: Mar. 7, 2013

(54) DEVICE FOR AUTOMATED DETECTION OF FEATURE FOR CALIBRATION AND METHOD THEREOF

(71) Applicants: Hyun KANG, Daejeon (KR); Jae Hean KIM, Yongin (KR); Ji Hyung LEE, Daejeon (KR); Bonki KOO, Daejeon (KR)

(72) Inventors: Hyun KANG, Daejeon (KR); Jae Hean KIM, Yongin (KR); Ji Hyung LEE, Daejeon (KR); Bonki KOO, Daejeon (KR)

(73) Assignee: Electronics and Telecommunications Research Institute, Daejeon (KR)

(21) Appl. No.: 13/571,295

(22) Filed: Aug. 9, 2012

(30) Foreign Application Priority Data
Sep. 6, 2011 (KR) 10-2011-0090094

(51) Int. Cl. G06K 9/46

(52) U.S. Cl. 382/103

(57) ABSTRACT

A method for automated detection of feature for calibration is provided, which includes capturing images of a polyhedral structure including a plurality of rectangular planes and triangular planes in different directions through a plurality of cameras, and generating a plurality of image files, each of the rectangular planes having calibration objects formed thereon to be used as input values of a calibration engine, and each of the triangular planes having a marker formed thereon to grasp absolute and relative relationships between the rectangular planes; searching for the calibration objects in the image files; searching for the same plane in which the calibration objects are formed using the calibration objects; and indexing the respective calibration objects formed on the same plane.

### CROSS-REFERENCES TO RELATED APPLICATIONS

The present application claims priority under 35 U.S.0 119(a) to Korean Application No. 10-2011-0090094, filed on Sep. 6, 2011, in the Korean Intellectual Property Office, which is incorporated herein by reference in its entirety set forth in full.

### BACKGROUND

Exemplary embodiments of the present invention relate to a device for automated detection of feature for calibration and a method thereof, and more particularly, to a device for automated detection of feature for calibration and a method thereof, which can perform automation of camera calibration in a computer vision system using a plurality of cameras.

A computer vision system has a plurality of cameras arranged to suit an actual vision application system to obtain a large number of information.

As information that is processed by the system having the plurality of cameras increases, problems of management and maintenance of the system occur. In particular, the cost for camera calibration that obtains intrinsic and extrinsic parameters of cameras in order to grasp the positions and postures of the cameras increases in proportion to the number of cameras.

Most computer vision systems using cameras determine the positions and postures of cameras in a space designated by a system designer. The positions and postures of the cameras are determined by obtaining three-dimensional (3D) positions (X, Y, Z) of the cameras and rotation values (expressed by a 3×3 matrix, 4-element vector quaternion, 3-element vector Euler angles, and the like) that indicate the postures of the cameras.

Work to obtain a transformation for converting world coordinates into camera coordinates through obtaining of the positions and postures of the cameras becomes a process to obtain the extrinsic parameters. Although the intrinsic parameters of the cameras may be more complicated depending on the characteristics of the cameras and the kinds of lenses, most systems obtain a 3×3 matrix under the assumption that the cameras are pinhole models. This matrix expresses the relationship between images actually output from the cameras and 3D camera coordinates.

According to Zhang's method that has been fairly frequently used (Z. Zhang, “A flexible new technique for camera calibration”, IEEE Transactions on Pattern Analysis and Machine Intelligence, Vol. 22, No. 11, pages 1330-1334, 2000), it is required to variously arrange calibration patterns and to capture more than three sheets of images in order to obtain intrinsic parameters of cameras for camera calibration. Further, in order to calculate extrinsic parameters, it is required to arrange patterns and to capture images of the patterns in a common area that can be seen by all cameras.

The calibration pattern is obtained by inputting a positional relationship between points that appear in an image using a pattern previously known and calibration objects in the pattern (points in the pattern for calibration) to a calibration engine as an input.

In particular, as the number of calibration objects in the calibration pattern becomes larger, the accuracy of the results obtained through a calibration algorithm becomes higher.

The background technology of the present invention is disclosed in Korean Unexamined Patent Publication No. 10-2010-0007506 (published on Jan. 22, 2010).

### SUMMARY

However, since the calibration method in the related art requires manual works, such as user's direct input of prior knowledge and user's designation of areas concerned, the work efficiency decreases and the cost for the calibration increases.

An embodiment of the present invention relates to a device for automated detection of feature for calibration and a method thereof, which can detect automated calibration features using a structure that can be captured in all directions in a computer vision system using a plurality of cameras.

In one embodiment, a device for automated detection of feature for calibration includes: a polyhedral structure including a plurality of rectangular planes and triangular planes, each of the rectangular planes having calibration objects formed thereon to be used as input values of a calibration engine, and each of the triangular planes having a marker formed thereon to grasp absolute and relative relationships between the rectangular planes.

The calibration object may be any one of a concentric circular pattern, a rectangular pattern, and a rectangular and inner-circular pattern.

The marker may include a triangular border of the triangular plane, a marker point, and a pattern.

The polyhedral structure may be an octagonal structure having 18 rectangular planes and 8 triangular planes.

In another embodiment, a method for automated detection of feature for calibration includes: capturing images of a polyhedral structure including a plurality of rectangular planes and triangular planes in different directions through a plurality of cameras, and generating a plurality of image files, each of the rectangular planes having calibration objects formed thereon to be used as input values of a calibration engine, and each of the triangular planes having a marker formed thereon to grasp absolute and relative relationships between the rectangular planes; searching for the calibration objects in the image files; searching for the same plane in which the calibration objects are formed using the calibration objects; and indexing the respective calibration objects formed on the same plane.

The method for automated detection of feature for calibration according to the embodiment may further include confirming whether the relationship is a rectangular relationship or a triangular relationship through a planar relationship according to a pair relationship between numerals after the indexing step; and recognizing a pattern formed on the triangular plane using the marker if the relationship is the triangular relationship.

The confirming step may confirm that the relationship between the numerals allocated to the calibration objects is the rectangular relationship if straight lines connecting order pairs do not meet each other and variation on the straight line connecting the order pairs is constant, and confirm that the relationship between the numerals is the triangular relationship if the image is present in the pair relationship.

The recognizing step may recognize the pattern using a template matching method or a neural network method.

The calibration object may be any one of a concentric circular pattern, a rectangular pattern, and a rectangular and inner-circular pattern.

The marker may include a triangular border of the triangular plane, a marker point, and a pattern.

According to the present invention, the costs for management, maintenance, and repair of the computer vision system can be remarkably reduced.

Further, according to the present invention, it is possible to perform automated detection and automated indexing of the automated calibration objects with respect to the existing plane patterns in which no structure is used.

### BRIEF DESCRIPTION OF THE DRAWINGS

The above and other aspects, features and other advantages will be more clearly understood from the following detailed description taken in conjunction with the accompanying drawings, in which:

FIG. 1 illustrates a perspective view of a structure according to an embodiment of the present invention;

FIG. 2 illustrates a view of a vision system using a structure according to an embodiment of the present invention;

FIG. 3 illustrates a development view developing a structure according to an embodiment of the present invention;

FIG. 4 illustrates a graph of rectangular planes of a structure according to an embodiment of the present invention;

FIG. 5 illustrates a view of features of numerals indicating a triangular relationship of a structure according to an embodiment of the present invention;

FIG. 6 illustrates a view of a triangular relationship of a structure through English characters and numerals according to an embodiment of the present invention;

FIGS. 7A and 7B illustrate views of an example of a pattern of a structure according to an embodiment of the present invention;

FIG. 8 illustrates a flowchart for automated detection of positions and relationships of calibration objects according to an embodiment of the present invention;

FIG. 9 illustrates a view of a rectangular relationship of relationships between planes of a structure according to an embodiment of the present invention; and

FIG. 10 illustrates a flowchart of a method for automated detection of calibration objects according to an embodiment of the present invention.

### DESCRIPTION OF SPECIFIC EMBODIMENTS

Hereinafter, a device for automated detection of feature for calibration and a method thereof according to an embodiment of the present invention will be described in detail with reference to accompanying drawings. In the drawings, line thicknesses or sizes of elements may be exaggerated for clarity and convenience. Also, the following terms are defined considering function of the present invention, and may be differently defined according to intention of an operator or custom. Therefore, the terms should be defined based on overall contents of the specification.

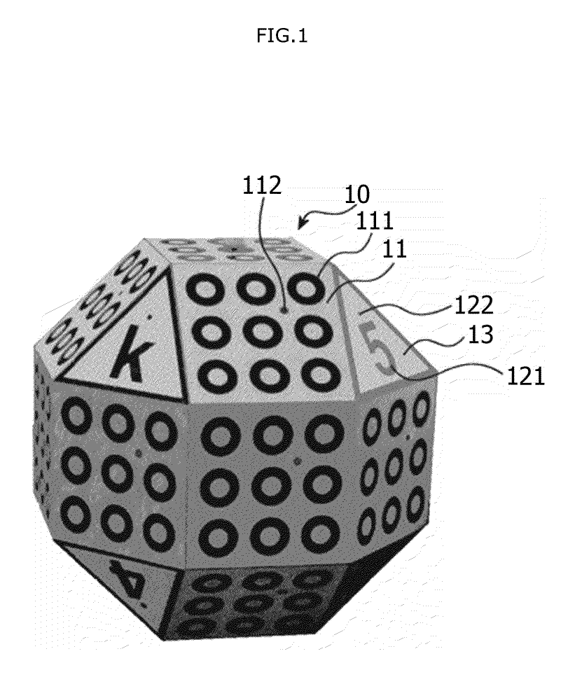

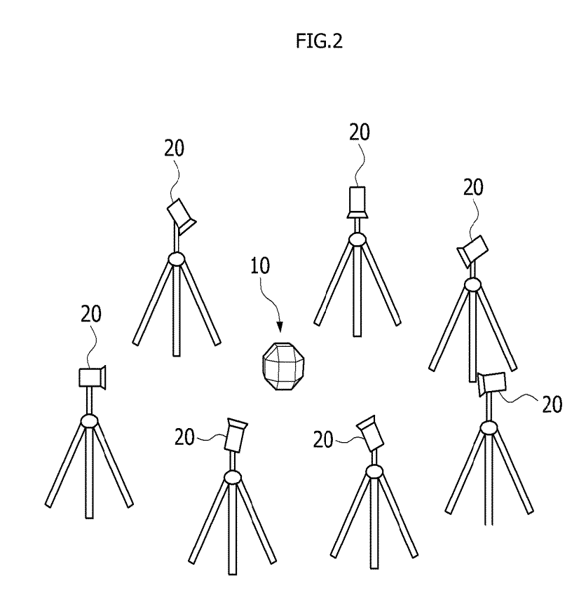

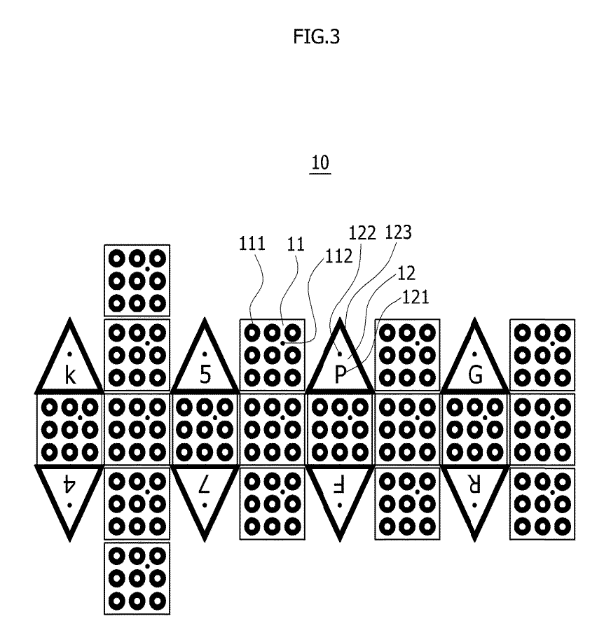

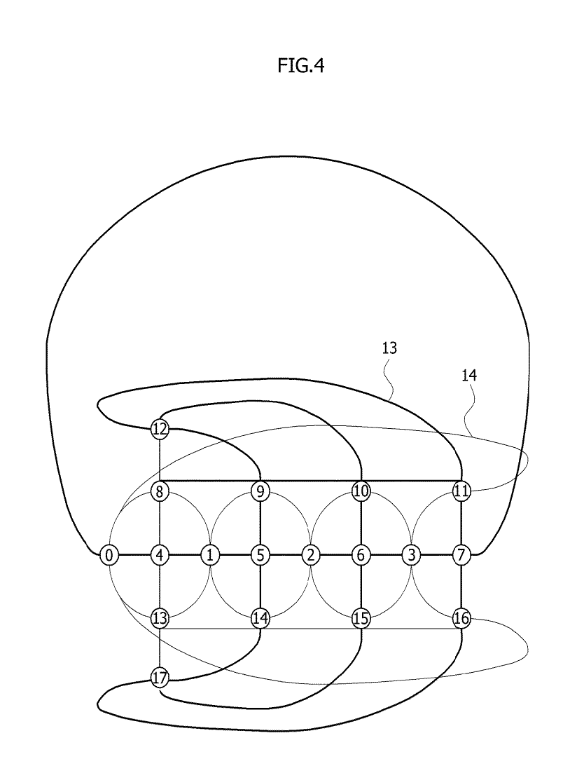

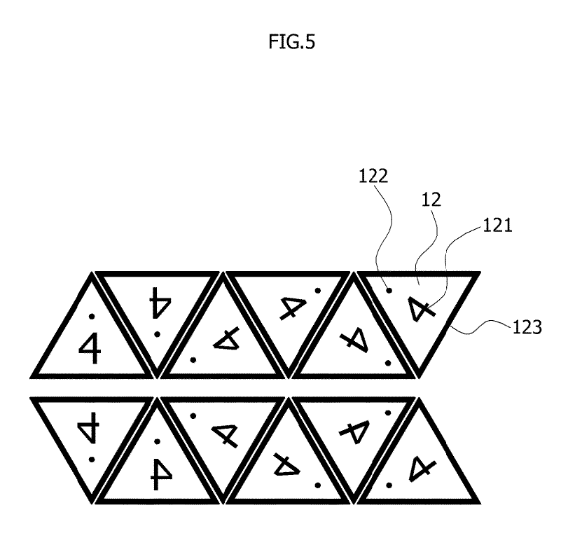

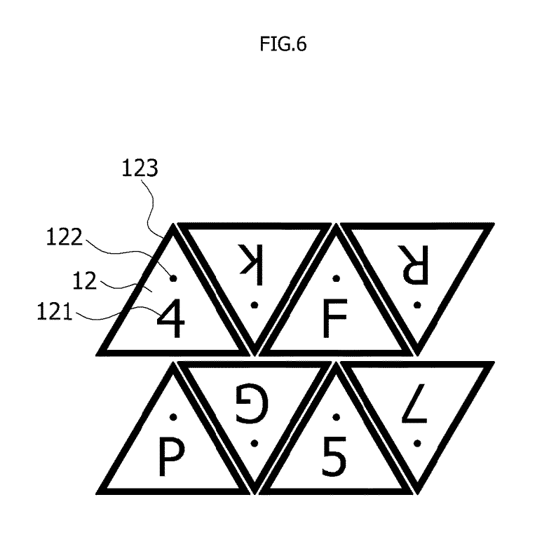

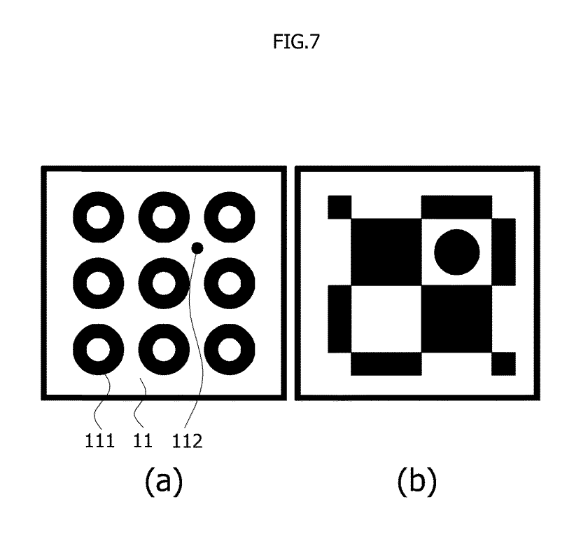

FIG. 1 illustrates a perspective view of a structure according to an embodiment of the present invention, and FIG. 2 illustrates a view of a vision system using a structure according to an embodiment of the present invention. FIG. 3 illustrates a development view developing a structure according to an embodiment of the present invention, and FIG. 4 illustrates a graph of rectangular planes of a structure according to an embodiment of the present invention. FIG. 5 illustrates a view of features of numerals indicating a triangular relationship of a structure according to an embodiment of the present invention, and FIG. 6 illustrates a view of a triangular relationship of a structure through English characters and numerals according to an embodiment of the present invention. FIGS. 7A and 7B illustrate views of an example of a pattern of a structure according to an embodiment of the present invention.

As illustrated in FIG. 1, a structure 10 according to an embodiment of the present invention is a polyhedron having an octagonal structure. The octagonal structure includes eighteen rectangular planes 11 and eight triangular planes 12.

A plurality of cameras 20 for capturing images are positioned around the octagonal structure 10, and angles formed between the cameras 20 and respective planes 11 and 12 of the octagonal structure 10 may be variously determined. For example, the angles may correspond to perpendicularity, inclination by 45 degrees or 135 degrees, or horizontality.

Accordingly, images captured by the respective cameras may be provided at the angles formed between the cameras 20 and the respective planes, such as perpendicularity, inclination by 45 degrees or 135 degrees, or horizontality.

Further, the octagonal structure 10 has a shape that is generally close to a sphere, and even if a plurality of cameras 20 captures images of one object like a motion capture system, similar shapes can be obtained from the respective cameras 20. This is advantageous when calibrating extrinsic parameters.

Referring to FIG. 2, it is assumed that a space in which viewing angles of the cameras 20 commonly overlap one another is a common area, and if the structure 10 is arranged in the common area, intrinsic and extrinsic parameters of the cameras 20 can be automatically estimated.

Similar computer vision systems may be motion capture systems of the cameras 20 or infrared sensors, silhouette-based external shape restoration systems, model-based simultaneous external shape and motion restoration systems, and the like.

Referring to FIG. 3, the configuration of each surface of the structure 10 can be confirmed. The structure 10 includes eighteen rectangular planes 11 on which calibration objects 111 in the form of a concentric ellipse are formed and eight triangular planes 12 on which markers for grasping absolute and relative relationships between the rectangular planes are formed.

The structure 10 provides graphs of the rectangular planes 11. Respective nodes indicate the rectangular planes 11 of the structure 10, and bent lines indicate edges of the respective planes 11 and 12. Here, thick lines 13 indicate edges that correspond to the relationship between the rectangular planes (upper, lower, left, and right), and thin lines 14 are to confirm the respective nodes by the edges having the triangular relationship.

Referring to FIGS. 3 and 4, the triangular relationships may be characters 121 having a triangular shape, for example, English characters or numerals, in an actual implementation.

They must have different shapes irrespective of the rotating direction of the structure 10. That is, even if the structure 10 is turned upside down or provides mirror images, they have different shapes, and thus rotated values can be known from the shapes of the captured images.

Referring to FIG. 5, features of English characters that indicate the triangular relationships are shown. As illustrated in FIG. 5, the characters 121 such as the English characters or the numerals have their own shapes in all directions.

Referring to FIG. 6, it can be known that the English characters and the numerals appear with their own shapes on the triangular planes 12 formed on the structure 10 according to this embodiment.

Accordingly, as shown in FIG. 5, if they have their own shapes in all directions, all patterns can be provided. In this case, patterns formed on the triangular planes 12, for example, points 122 stamped on the triangular borders 123 and characters 121, make it possible to accurately recognize the markers.

On the rectangular plane 11, calibration objects 11 are actually formed, and these calibration objects 11 are used as input values of a calibration engine (not illustrated).

In this embodiment, as shown in FIGS. 7A and 7B, concentric circular shapes are adopted. However, the technical range of the present invention is not limited thereto, and various types of calibration objects 111 can be adopted.

As described above, in this embodiment, it is exemplified that a projective transformation property of the concentric circle is used. In this case, the center of the concentric circle for determining intrinsic and extrinsic parameters is not used, but the characteristic that the concentric circle can be easily searched for in an image as compared with other figures is utilized. As a result, concentric circles are searched for in images and the relationship between the calibration objects 111 can be confirmed through the mutual relationships between the concentric circles.

In this embodiment, in order to confirm the relationship between the calibration objects 11, ellipse fitted center (Andrew Fitzgibbon, Maurizio Pilu, and Robert B. Fisher, “Direct Least Square Fitting of Ellipses”, PATTERN ANALYSIS AND MACHINE INTELLIGENCE, Vol. 21, NO. 5, MAY 1999) has been used.

For reference, in this embodiment, as shown in FIG. 7A, it is exemplified that the rectangular plane 11 of the concentric circular pattern is configured by 3×3 concentric circles and a point 112 for designating the order of the calibration. However, the technical range of the present invention is not limited thereto, and various patterns such as block patterns may be configured as shown in FIG. 7B.

On the other hand, by acquiring the positions and relationships of the calibration objects 111 using the calibration objects 111 formed on the structure 10 as described above, the features can be accurately detected.

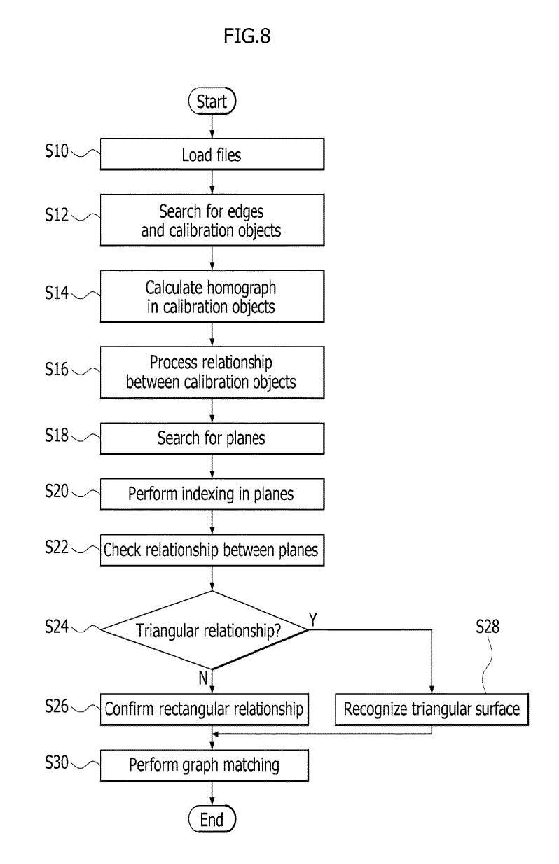

This will be described with reference to FIGS. 8 to 10.

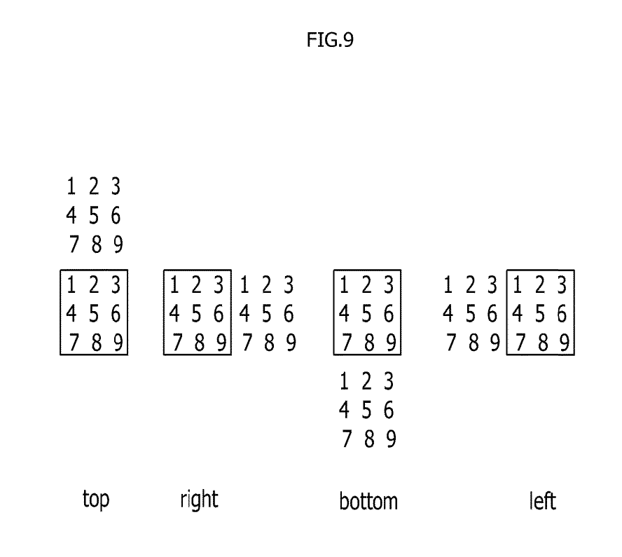

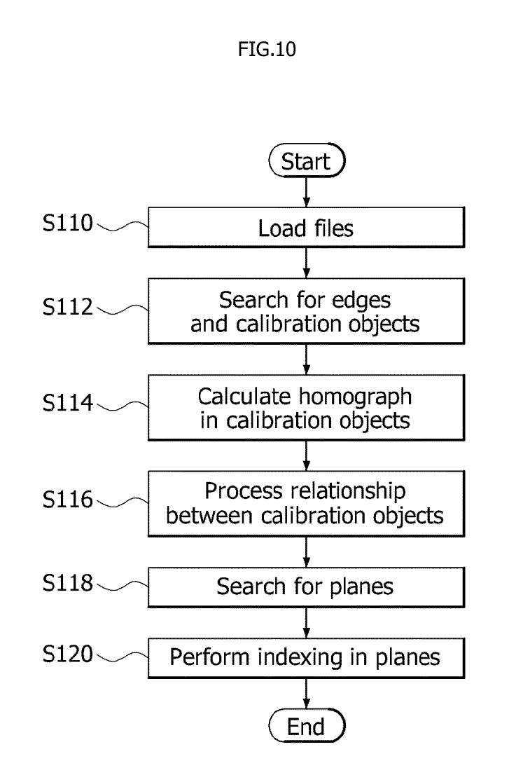

FIG. 8 illustrates a flowchart for automated detection of positions and relationships of calibration objects according to an embodiment of the present invention, and FIG. 9 illustrates a view of a rectangular relationship of relationships between planes of a structure according to an embodiment of the present invention. FIG. 10 illustrates a flowchart of a method for automated detection of calibration objects according to an embodiment of the present invention.

According to a method for acquiring the positions and relationships of the calibration objects 111 according to this embodiment, images of the structure 10 are captured by a plurality of cameras 20, and then files of the captured images are loaded (S10).

In this case, a user can recognize and selects the images captured by the respective cameras 20. That is, the user can select at least one of the captured images from which the calibration objects 111 are to be searched for.

If the image from which the calibration objects 111 are to be searched for is selected by the user, edges of the structure 10 and the calibration objects 111 are searched for from the selected image (S12).

Here, since the calibration objects 111 are formed on the same rectangular plane 11 according to the pattern, the corresponding rectangular plane 11 on which the calibration objects 111 are formed is searched for after the edges of the structure 10 and the calibration objects 11 are searched for.

That is, if N nearest calibration objects 111, for example, four nearest calibration objects 111, are collected, homography transform is obtained in the corresponding calibration objects 111 under the assumption that the calibration objects 111 are formed on the same rectangular plane 11 (S14).

As described above, if the calibration objects 111 are projected on the plane by the homography transform, this space provides a basis from which it can be known which calibration objects 111 are provided on upper, lower, left, and right sides, or which calibration objects 111 are formed on the same rectangular plane 11, and through this, the relationships between the calibration objects 111 are processed (S16).

In this embodiment, since 3×3 calibration objects 111 are provided on one rectangular plane 11, the following planes can be assumed.

First, the rectangular plane 11 is composed of one calibration object 111 having eight neighboring relationships and eight neighboring calibration objects 111 only.

Second, a pair of the calibration object 111 positioned on a diagonal line and the calibration object 111 positioned on a vertical/horizontal line can be discriminated through cross-ratio.

Through such a plane assumption, the plane 111 on which the calibration objects 111 are formed in the image can be obtained. That is, in this embodiment, the octagonal structure is a polyhedron having eighteen rectangular planes and eight triangular planes, and the eighteen rectangular planes 11 can be searched for and confirmed through the above-described process (S18).

In the structure 10 according to this embodiment, there are two kinds of relationships between the planes 11 and 12. They are a rectangular relationship and a triangular relationship.

Referring to FIG. 9, the numerals on the respective triangular planes 12 are indexed by determining the order of the calibration objects 111 through the points 112 formed on the rectangular planes 11 after the rectangular planes 11 are found (S20). For example, numerals of 1 to 9 are successively allocated from the left upper end to the right lower end.

Thereafter, it is recognized whether the relationship between the planes is the triangular relationship or the rectangular relationship through the relationship between the numerals (S22).

At this time, the relationship becomes the rectangular relationship in the case where the relationship between the numerals satisfies the following assumptions.

First assumption is that the straight lines connecting the order pairs do not meet each other, and the second assumption is that the variation on the straight lines connecting the order pairs is constant.

Accordingly, if the two assumptions are all satisfied, it can be known that the relationship becomes the rectangular relationship.

On the other hand, the triangular relationship is realized if an image is present in the above-described pair relationship. The pattern in such as image can be recognized through a pattern recognition engine together with the direction thereof.

For pattern recognition, a template matching method or a pattern recognition engine that is advantageous to recognize a static pattern such as a neural network may be introduced if necessary. Particularly, in the case of using the engine such as the neural network, the problem that it is difficult to obtain points 122 in the pattern during low-resolution image capturing can be solved.

As illustrated in FIGS. 5 and 6, the triangular pattern has four important points, that is, three vertices of the triangle and a marker point in the pattern.

By obtaining the homography using these points, deskew pattern images can be obtained.

On the other hand, due to image noise, the plane assumption that is set to recognize the triangular relationship or the rectangular relationship may become inaccurate. Accordingly, in order to search for an accurate relationship between the planes even in the inaccurate triangular or rectangular relationship, a graph matching method may be used.

In this case, a sub-graph is configured on the basis of the triangular or rectangular relationship obtained from the image, the rectangular relationship has only a relative relationship between the planes that is relatively accurate, and the triangular relationship provides an inaccurate absolute position.

The pattern recognition engine provides a plurality of resultant values, and based on these value, a plurality of sub-graphs are generated. These sub-graphs have pattern coincidence level values output from the pattern recognition engine. Accordingly, as shown in FIG. 4, the sub-graph having the highest pattern coincidence level value of the generated sub-graphs as shown in FIG. 4 is selected as the result of the relationship between the planes.

In addition, the method for acquiring the positions and relationships of the calibration objects 111 as described above can be applied to the method for automatically searching for the calibration objects 111.

That is, as shown in FIG. 10, the images captured by the cameras 20 are loaded, the edges and the concentric circles are searched for from the images, and calibration objects are projected on the planes by the homography transform. Thereafter, the plane is searched for by processing the relationship between the calibration objects 111, and then the calibration objects 111 formed on the plane are searched for by indexing the calibration objects 111 formed on the corresponding plane (S110 to S120).

Since this process is the same as the process illustrated in FIG. 8, the detailed description thereof will be omitted.

The embodiment of the present invention has been disclosed above for illustrative purposes. Those skilled in the art will appreciate that various modifications, additions and substitutions are possible, without departing from the scope and spirit of the invention as disclosed in the accompanying claims.

What is claimed is:

1. A device for automated detection of feature for calibration comprising:
a polyhedral structure including a plurality of rectangular planes and triangular planes, each of the rectangular planes having calibration objects formed thereon to be used as input values of a calibration engine, and each of the triangular planes having a marker formed thereon to grasp absolute and relative relationships between the rectangular planes.

2. The device for automated detection of feature for calibration of claim 1, wherein the calibration object is any one of a concentric circular pattern, a rectangular pattern, and a rectangular and inner-circular pattern.

3. The device for automated detection of feature for calibration of claim 1, wherein the marker includes a triangular border of the triangular plane, a marker point, and a pattern.

4. The device for automated detection of feature for calibration of claim 1, wherein the polyhedral structure is an octagonal structure having 18 rectangular planes and 8 triangular planes.

5. A method for automated detection of feature for calibration comprising:
capturing images of a polyhedral structure including a plurality of rectangular planes and triangular planes in different directions through a plurality of cameras, and generating a plurality of image files, each of the rectangular planes having calibration objects formed thereon to be used as input values of a calibration engine, and each of the triangular planes having a marker formed thereon to grasp absolute and relative relationships between the rectangular planes;
searching for the calibration objects in the image files;
searching for the same plane in which the calibration objects are formed using the calibration objects; and
indexing the respective calibration objects formed on the same plane.

6. The method for automated detection of feature for calibration of claim 5, further comprising:
confirming whether the relationship is a rectangular relationship or a triangular relationship through a planar relationship according to a pair relationship between numerals after the indexing step; and
recognizing a pattern formed on the triangular plane using the marker if the relationship is the triangular relationship.

7. The method for automated detection of feature for calibration of claim 6, wherein the confirming step confirms that the relationship between the numerals allocated to the calibration objects is the rectangular relationship if straight lines connecting order pairs do not meet each other and variation on the straight line connecting the order pairs is constant, and confirms that the relationship between the numerals is the triangular relationship if the image is present in the pair relationship.

8. The method for automated detection of feature for calibration of claim 6, wherein the recognizing step recognizes the pattern using a template matching method or a neural network method.

9. The method for automated detection of feature for calibration of claim 6, wherein the calibration object is any one of a concentric circular pattern, a rectangular pattern, and a rectangular and inner-circular pattern.

10. The method for automated detection of feature for calibration of claim 6, wherein the marker includes a triangular border of the triangular plane, a marker point, and a pattern.
